(19) United States
(12) Patent Application Publication
(10) Pub. No.: US 2020/0027713 A1
(43) Pub. Date: Jan. 23, 2020

(54) Apparatuses for Detecting Constituents in a Sample and Method of Using the Same

(71) Applicant: Rapiscan Systems, Inc., Torrance, CA (US)

(72) Inventors: Gary A. Eiceman, Las Cruces, NM (US); Stephen J. Davila, Pearland, TX (US); Stefan R. Lukow, Windham, NH (US); Hartwig Schmidt, Tewksbury, MA (US)

(21) Appl. No.: 16/415,105

(22) Filed: May 17, 2019

Related U.S. Application Data
(63) Continuation-in-part of application No. 16/031,087, filed on Jul. 10, 2018.
Application No. 16/031,087 is a continuation of application No. 15/370,947, filed on Dec. 6, 2016, now Pat. No. 10,049,868.
Application No. 15/370,947 is a continuation-in-part of application No. PCT/US17/64702, filed on Dec. 5, 2017.
Application No. PCT/US17/64702 is a continuation of application No. 15/370,947, filed on Dec. 6, 2016, now Pat. No. 10,049,868.
(60) Provisional application No. 62/676,619, filed on May 25, 2018.

(51) Int. Cl. H01J 49/40; G01N 27/62; H01J 49/00

(52) U.S. Cl. CPC H01J 49/401; H01J 49/0045; G01N 27/622

(57) ABSTRACT

An apparatus for detecting constituents in a sample includes first and second drift tubes defining first and second drift regions and a controllable electric field device within a fragmentation region coupled to the first and second drift tubes. The apparatus also includes a first ion shutter positioned between the first drift and fragmentation regions. The apparatus further includes a control system configured to regulate the first ion shutter, thereby facilitating injection of a selected portion of ions from the first drift region into the fragmentation region. The control system is also configured to regulate the controllable device to modify the selected portion of ions to generate predetermined ion fragments within the fragmentation region, thereby facilitating injection of a selected portion of the predetermined fragmented ions into the second drift region. A method of detecting constituents in a sample is facilitated through such an apparatus.

### CROSS-REFERENCE

The present application relies on U.S. Patent Provisional Application No. 62/676,619, filed on May 25, 2018, entitled “Apparatus for Detecting Constituents in a Sample and Methods of Using the Same”, for priority, which is hereby incorporated by reference herein in its entirety.

The present application is also a continuation-in-part application of U.S. patent application Ser. No. 16/031,087, filed on Jul. 10, 2018, of the same title, which is a continuation application of U.S. patent application Ser. No. 15/370,947, filed on Dec. 6, 2016, of the same title, and issued as U.S. Pat. No. 10,049,868 on Aug. 14, 2018, both of which are hereby incorporated by reference herein in their entirety.

The present application is also a continuation-in-part application of PCT Application Number PCT/US17/64702, filed on Dec. 5, 2017, of the same title, which is a continuation application of U.S. patent application Ser. No. 15/370,947, and which is hereby incorporated by reference herein in its entirety.

### FIELD

The embodiments described herein relate generally to ion mobility spectrometer (IMS) systems and ion trap mobility spectrometer (ITMS) systems and, more particularly, to IMS and ITMS detection systems for enhancing detection of materials of interest through enhanced information derived from fragmented ions.

### BACKGROUND

At least some known spectrometric detection devices include a time-of-flight (TOF) ion mobility spectrometer (IMS) detection system and a TOF ion trap mobility spectrometer (ITMS) detection system. Such TOF-IMS and TOF-ITMS detection systems are used to detect trace amounts of materials of interest, e.g., residues, in the presence of interfering substances in collected samples. In at least some known IMS and ITMS systems, ions are generated in an ionization chamber to increase the ion population therein and a retaining grid or an ion gate is maintained at a potential to induce a retention field and reduce the potential for ion leakage from the chamber. The ions are “pulsed” from the ionization chamber into a drift region through the retaining grid or ion gate. The ions are transported through the drift region to a collector electrode using an electric field. Signals representative of the ion population at the collector electrode are generated and transmitted to an analysis instrument and/or system to determine the constituents in the collected gas samples. Based on an ions' mass, charge, size, and shape, the ion mobility determines the migration time through the drift region which is characteristic of different ions, leading to the ability to distinguish different analyte species.

However, many known drift tubes of IMS and ITMS systems have a limited resolving power. As peaks generated by ions from different compounds share similar drift times, some of the interferences, including benign substances, have the same drift times as the analyte compounds of interest associated with an increasing number of threats programmed into the detection library and, therefore, create false alarms. A number of methods and apparatuses have been used to characterize the ions of interest and to decrease the false alarm rate which is addressed by the concept of the reactive drift tubes.

One method proposed to decrease the false alarm rate is fragmentation, i.e., the dissociation of energetically unstable molecular ions to form ion fragments of a molecule that induce a pattern in the mass spectrum or mobility spectrum used to determine structural information of the original molecule. Fragmentation can be achieved through a variety of means, including fragmentation induced by collision induced dissociation (CID) with selected gases injected into the flow path of the apparatus, fragmentation induced through a set of electrodes capable of generating electric fields with sufficiently high electric field strength to thermally form disassociated products, dissociation through laser that, depending on the required wavelength and molecules to be dissociated, uses one of photodissociation, infrared multiphoton dissociation, and thermal dissociation. Further methods of fragmentation include electron capture and transfer methods through injection of active chemicals.

Some known IMS and ITMS systems use ion dissociation through a high-voltage radio-frequency (HV RF) unit positioned within the drift tube. However, such IMS and ITMS systems lack the selection of ions to be fragmented, e.g., through a second ion shutter before the HV-RF unit. Therefore, most of the ions to be fragmented and the fragmented ions enter the second portion of the drift region without any screening, regardless of the chemical makeup of the fragmented ions. As such, the assignment of the fragment ions to spectral patterns is complex with little to no discrimination. The results may be ambiguous because the ability to discern the identity of the resulting fragments is limited since the ions to be dissociated are not separated from the other ions. In some of these known IMS and ITMS systems, operation at reduced pressures is one attempt of reducing the number of ion collisions and thus reducing the number of fragments to generate a more simplistic raw data stream, but the simplicity of the IMS and ITMS techniques is compromised by adding the additional hardware, such as vacuum chambers and pumps.

U.S. Pat. No. 8,436,299 discloses “[a] detector, comprising: an ionizer; a collector plate; and a drift chamber; wherein the drift chamber comprises: at least one first electrode pair for causing ions to move to the collection plate, and an ion modifier disposed in the drift chamber, the ion modifier configured to modify ion mobilities of respective ones of the ions.” Such tandem drift tube devices use laser irradiation and vapor injection to fragment ions and promote selective reactions and additional analytical selectivity. However, such mechanisms substantially form adducts with the selected ions that are transferred to a third drift tube through another ion control grid for characterization therein. Also, uncontrolled movement of sample neutrals between mobility regions facilitates ion molecule reactions in the drift regions that further complicate the interpretation of the resultant spectra.

### SUMMARY

The present specification discloses an apparatus for detecting constituents in a sample, said apparatus comprising: a first drift tube defining a first drift region; a second drift tube defining a second drift region; a controllable electric field device coupled to said first drift tube and said second drift tube, said controllable electric field device at least partially defining a fragmentation region comprising a first wire grid, a second wire grid and a third wire grid spaced from each other along a longitudinal axis of the fragmentation region; and a control system coupled to said controllable electric field device for controlling injection of a selected portion of ions of the sample into said second drift region, said control system further controlling injection of a selected portion of ions of the sample from said first drift region into said fragmentation region, and regulating said controllable electric field device to modify the selected portion of ions to generate predetermined ion fragments within said fragmentation region.

Optionally, the first wire grid and the second wire grid are spaced from each other by a distance ranging from 10 μm to 2 mm.

Optionally, the second wire grid and the third wire grid are spaced from each other by a distance ranging from 0.1 mm to 8 mm.

Optionally, the apparatus further comprises a first ion shutter positioned between said first drift region and said fragmentation region, said first ion shutter being coupled with the control system. Optionally, said control system is configured to regulate the first ion shutter a first predetermined temporal period in order to control the injection of the selected portion of ions from the first drift region into the fragmentation region.

Optionally, the apparatus further comprises an ion trap positioned between the fragmentation region and the second drift region, wherein the control system is further coupled to the ion trap and configured to regulate the ion trap for a second predetermined temporal period in order to inject a selected portion of the predetermined fragmented ions into the second drift region.

Optionally, the apparatus further comprises: an ion detector positioned downstream of said second drift region; and a spectral analysis device coupled to said ion detector, said spectral analysis device configured to generate a detection spectrum representative of ions detected at said ion detector.

The present specification also discloses a mobility spectrometer for detecting constituents in a sample, wherein the mobility spectrometer comprises: a first drift tube defining a first mobility stage; a second drift tube defining a second mobility stage; a controllable electric field device coupled to said first drift tube and said second drift tube, said controllable electric field device at least partially defining a fragmentation region comprising a first wire grid, a second wire grid and a third wire grid, wherein the first wire grid is situated upstream with respect to the second wire grid and the third wire grid within the fragmentation region, and the third wire grid is situated downstream with respect to the first wire grid and the second wire grid within the fragmentation region, and wherein the first wire grid and the third wire grid are separated by a distance ranging from 0.1 mm to 8 mm; and a processor coupled to said first and second drift tubes and said controllable electric field, wherein the processor is configured to detect the sample as a sample of interest if: the sample ionizes within the spectrometer forming a product ion distinctive of the sample of interest; the product ion exhibits a first predefined drift time corresponding to the sample of interest in the first mobility stage; the product ion fragments at a predefined electric field value within the fragmentation region; and the product ion, or portions thereof, exhibit a second predefined drift time corresponding to the sample of interest in the second mobility stage.

Optionally, the mobility spectrometer further comprises a first ionization source coupled with a first drift region for ionizing the sample to form sample ions, wherein the sample ions are injected into the first drift region; and a control system coupled to said controllable electric field device for controlling injection of a selected portion of the sample ions into a second drift region, said control system further controlling injection of a selected portion of the sample ions from said first drift region into said fragmentation region; and regulating said controllable electric field device to modify the selected portion of ions to generate predetermined ion fragments within said fragmentation region.

Optionally, the mobility spectrometer further comprises: an ion detector positioned downstream of said second drift region; and a spectral analysis device coupled to said ion detector, said spectral analysis device configured to generate a detection spectrum representative of ions detected at said ion detector. Optionally, the processor is coupled with said spectral analysis device.

Optionally, the first wire grid and the second wire grid are spaced from each other by a distance ranging from 10 μm to 2 mm.

Optionally, the second wire grid and the third wire grid are spaced from each other by a distance ranging from 0.1 mm to 8 mm.

Optionally, the mobility spectrometer further comprises a first ion shutter positioned between said first drift region and said fragmentation region wherein the first ion shutter is coupled with the control system. Optionally, said control system is configured to regulate the first ion shutter for a first predetermined temporal period and control the injection of the selected portion of ions from the first drift region into the fragmentation region. Optionally, the mobility spectrometer further comprises an ion trap positioned between said fragmentation region and said second drift region, wherein said control system is further coupled to said ion trap and configured to regulate the ion trap for a second predetermined temporal period in order to inject a selected portion of the predetermined fragmented ions into said second drift region.

The present specification also discloses a method of detecting a presence of a composition of matter in a sample, said method comprising: channeling a sample gas into an ionization region; generating a plurality of ions in the ionization region; injecting at least a portion of the ions from the ionization region into a first drift region; injecting a selected portion of ions from the first drift region into a fragmentation region, wherein the fragmentation region is defined by a first wire grid, a second wire grid and a third wire grid, wherein the first wire grid is situated upstream with respect to the second wire grid and the third wire grid within the fragmentation region, and the third wire grid is situated downstream with respect to the first wire grid and the second wire grid within the fragmentation region, and wherein the first wire grid and the third wire grid are separated by a distance ranging from 0.05 mm to 10 mm; and detecting the sample as the composition of matter if and only if the sample ionizes within the spectrometer forming a product ion distinctive of the composition of matter, the product ion exhibits a first predefined drift time corresponding to the composition of matter in the first mobility stage, the product ion fragments at a predefined electric field value within the fragmentation region, and the product ion, or portions thereof, exhibit a second predefined drift time corresponding to the composition of matter in the second mobility stage.

Optionally, the method further comprises maintaining a distance ranging from 10 μm to 2 mm between the first wire grid and the second wire grid.

Optionally, the method further comprises maintaining a distance ranging from 0.05 mm to 10 mm between the second wire grid and the third wire grid.

Optionally, the ionization region is situated upstream with respect to the first drift region. Optionally, the method further comprises performing a controlled injection of a selected portion of the ions from said first drift region into the fragmentation region, regulating a controllable electric field device coupled with the fragmentation region to modify the selected portion of ions to generate predetermined ion fragments within the fragmentation region, and performing a controlled injection of a selected portion of the ion fragments into the second drift region. Optionally, the method further comprises regulating a first ion shutter for a first predetermined temporal period and controlling the injection of the selected portion of ions from said first drift region into said fragmentation region, wherein the first ion shutter is positioned between the first drift region and the fragmentation region. Optionally, the method further comprises regulating an ion trap for a second predetermined temporal period in order to inject a selected portion of the ion fragments into the second drift region, wherein the ion trap is positioned between the fragmentation region and the second drift region.

In one aspect, an apparatus for detecting constituents in a sample is provided. The apparatus includes a first drift tube defining a first drift region, a second drift tube defining a second drift region, and a controllable electric field device coupled to the first drift tube and the second drift tube. The controllable electric field device at least partially defines a fragmentation region. The apparatus also includes a first ion shutter positioned between the first drift region and the fragmentation region. The apparatus also includes a control system coupled to the controllable electric field device and the first ion shutter. The control system is configured to facilitate injection of a selected portion of the predetermined fragmented ions into the second drift region. The control system includes a processor and is also configured to regulate the first ion shutter a first predetermined temporal period, thereby facilitating injection of a selected portion of ions from the first drift region into the fragmentation region. The control system is further configured to regulate the controllable electric field device to modify the selected portion of ions to generate predetermined ion fragments within the fragmentation region.

In another aspect, a method of detecting constituents in a sample is provided. The method includes channeling a sample gas stream to be tested for constituents into an ionization region, generating a plurality of ions in the ionization region, and injecting at least a portion of the ions from the ionization region into a first drift region. The method also includes injecting a selected portion of ions from the first drift region into a fragmentation region including regulating a first ion shutter a first predetermined temporal period, where the first ion shutter is positioned between the first drift region and the fragmentation region. The method further includes modifying the selected portion of ions, thereby generating predetermined ion fragments within the fragmentation region including regulating a controllable electric field device positioned within the fragmentation region.

In some embodiments, the present specification discloses an apparatus for detecting constituents in a sample, said apparatus comprising: a first drift tube defining a first drift region; a second drift tube defining a second drift region; a controllable electric field device coupled to said first drift tube and said second drift tube, said controllable electric field device at least partially defining a fragmentation region; a first ion shutter positioned between said first drift region and said fragmentation region; and a control system coupled to said controllable electric field device and said first ion shutter, said control system comprising a processor, said control system configured to facilitate injection of a selected portion of the predetermined fragmented ions into said second drift region, said control system further configured to: regulate said first ion shutter a first predetermined temporal period, thereby facilitating injection of a selected portion of ions from said first drift region into said fragmentation region; and regulate said controllable electric field device to modify the selected portion of ions to generate predetermined ion fragments within said fragmentation region.

Optionally, said first drift tube, said first ion shutter, said controllable electric field device, and said second drift tube define a tandem drift tube configuration.

Optionally, the apparatus further comprises a dopant injection conduit coupled in flow communication with said fragmentation region.

Optionally, said control system configured to regulate said first ion shutter a first predetermined temporal period is further configured to facilitate discarding a non-selected portion of ions to reduce injection of the non-selected portion of ions into said fragmentation region.

Optionally, said control system configured to regulate said controllable electric field device to modify the selected portion of ions to generate predetermined ion fragments within said fragmentation region is further configured to regulate said controllable electric field device to dissociate a first portion of the selected portion of ions into a first portion of the predetermined ion fragments for further transmission to said second drift region.

Optionally, said control system configured to regulate said controllable electric field device to modify the selected portion of ions to generate predetermined ion fragments within said fragmentation region is further configured to regulate said controllable electric field device to dissociate non-selected ions into fragments for discarding.

Optionally, said control system configured to regulate said controllable electric field device to modify the selected portion of ions to generate predetermined ion fragments within said fragmentation region is further configured to regulate said controllable electric field device to not dissociate non-selected ions into fragments.

Optionally, said control system configured to regulate said controllable electric field device to modify the selected portion of ions to generate predetermined ion fragments within said fragmentation region is further configured to regulate said controllable electric field device to facilitate weakening of ion bonds in cooperation with an electrostatic charge of each ion of the selected portion of ions until ion fragmentation into the predetermined ion fragments is achieved.

Optionally, said apparatus is a time-of-flight (TOF) ion trap mobility spectrometer (ITMS) detection system, said apparatus further comprising: a casing; an ionization chamber at least partially defined by said casing, said ionization chamber configured to generate and store ions, said ionization chamber communicatively coupled to said control system; and a retaining grid coupled in flow communication with said ionization chamber and said first drift region, said retaining grid at least partially defining an ion trap, said control system further configured to regulate ion transmission into said first drift region through said retaining grid and through pulsing said ionization chamber.

Optionally, said apparatus is a time-of-flight (TOF) ion mobility spectrometer (IMS) detection system, said apparatus further comprising: a casing; an ionization chamber at least partially defined by said casing, said ionization chamber configured to generate and store ions, said ionization chamber communicatively coupled to said control system; and an ion gate device coupled in flow communication with said ionization chamber and said first drift region, said ion gate device further operably coupled to said control system, said control system further configured to regulate ion transmission into said first drift region through pulsing said ionization chamber and de-energizing said ion gate device.

Optionally, the apparatus further comprises an ion detector positioned downstream of said second drift region; and a spectral analysis device coupled to said ion detector, said spectral analysis device configured to generate a detection spectrum representative of ions detected at said ion detector.

Optionally, the apparatus further comprises a second ion shutter positioned between said fragmentation region and said second drift region, wherein said control system is further coupled to said second ion shutter, said control system further configured to regulate said second ion shutter a second predetermined temporal period, thereby further facilitating injection of a selected portion of the predetermined fragmented ions into said second drift region.

Optionally, the apparatus further comprises at least two wire grids in the fragmentation region.

Optionally, the apparatus further comprises an ion trap positioned between said fragmentation region and said second drift region, wherein said control system is further coupled to said ion trap, said control system further configured to regulate said ion trap a second predetermined temporal period, thereby further facilitating injection of a selected portion of the predetermined fragmented ions into said second drift region.

Optionally, the apparatus further comprises a first wire grid, a second wire grid, and an auxiliary third wire grid in the fragmentation region.

In some embodiments, the present specification discloses a method of detecting constituents in a sample, said method comprising: channeling a sample gas stream to be tested for constituents into an ionization region; generating a plurality of ions in the ionization region; injecting at least a portion of the ions from the ionization region into a first drift region; injecting a selected portion of ions from the first drift region into a fragmentation region comprising regulating a first ion shutter a first predetermined temporal period, the first ion shutter positioned between the first drift region and the fragmentation region; and modifying the selected portion of ions, thereby generating predetermined ion fragments within the fragmentation region comprising regulating a controllable electric field device positioned within the fragmentation region.

Optionally, the method further comprises injecting a dopant into the fragmentation region and mixing at least a portion of the injected dopant with the selected portion of ions from the first drift region.

Optionally, regulating a first ion shutter a first predetermined temporal period comprises discarding a non-selected portion of ions, thereby reducing injection of the non-selected portion of ions into the fragmentation region. Still optionally, regulating the controllable electric field device positioned within the fragmentation region comprises regulating the controllable electric field device to dissociate a first portion of the selected portion of ions into a first portion of the predetermined ion fragments for further transmission to the second drift region. Optionally, regulating the controllable electric field device positioned within the fragmentation region further comprises dissociating non-selected ions into fragments for discarding. Optionally, regulating the controllable electric field device positioned within the fragmentation region further comprises not dissociating non-selected ions into fragments. Optionally, regulating the controllable electric field device positioned within the fragmentation region further comprises weakening ion bonds in cooperation with an electrostatic charge of each ion of the selected portion of ions until ion fragmentation into the predetermined ion fragments is achieved.

In some embodiments, injecting at least a portion of the ions from the ionization region into a first drift region may comprise: storing the ions in the ionization region; and regulating ion injection into the first drift region through a retaining grid comprising pulsing the ionization region.

In still other embodiments, injecting at least a portion of the ions from the ionization region into a first drift region may comprise: storing the ions in the ionization region; and regulating ion injection into the first drift region through pulsing the ionization chamber comprising de-energizing an ion gate device.

Optionally, the method further comprises transmitting the selected portion of the predetermined fragmented ions through the second drift region to an ion detector.

Optionally, the method further comprises generating a detection spectrum representative of the ions detected at the ion detector through a spectral analysis device coupled to the ion detector.

Optionally, transmitting the selected portion of the predetermined fragmented ions through the second drift region comprises regulating a second ion shutter a second predetermined temporal period, the second ion shutter positioned between the second drift region and the fragmentation region.

Optionally, transmitting the selected portion of the predetermined fragmented ions through the second drift region comprises regulating an ion trap a second predetermined temporal period, the ion trap positioned between the second drift region and the fragmentation region.

Optionally, in another aspect of the present specification, the fragmentation region is defined by a two-grid fragmenter comprising a first wire grid and a second wire grid spaced from each other along a longitudinal axis of the fragmentation region.

Optionally, the first wire grid and second wire grid enable operation of the detection system 500 through production of a strong electric field in a range of 20 to 30,000 V/cm.

Optionally, in another aspect of the present specification, the fragmentation region is defined by a three-grid fragmenter comprising a first wire grid, a second wire grid, and a third wire grid spaced from each other along a longitudinal axis of the fragmentation region. Optionally, the third wire grid is positioned upstream with reference to the first wire grid and spaced by a distance from the first wire grid. In some optional embodiments, the distance ranges from 10 μm to 2 mm.

The aforementioned and other embodiments of the present specification shall be described in greater depth in the drawings and detailed description provided below.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic view of an exemplary ion trap mobility spectrometer (ITMS) detection system;

FIG. 2A is a schematic view of an alternative ion trap mobility spectrometer (ITMS) detection system;

FIG. 2B is a block diagram illustrating criteria to be met by a sample substance for positive detection as an explosive by using IMS system, in accordance with an embodiment of the present specification;

FIG. 2C is a flowchart illustrating a first criterion for a sample substance to be identified as an explosive substance by using an IMS system, in accordance with an embodiment of the present specification;

FIG. 2D is a flowchart illustrating a second criterion for a sample substance to be identified as an explosive substance by using an IMS system, in accordance with an embodiment of the present specification;

FIG. 2E is a flowchart illustrating a third criterion for a sample substance to be identified as an explosive substance by using an IMS system, in accordance with an embodiment of the present specification;

FIG. 2F is a flowchart illustrating a fourth criterion for a sample substance to be identified as an explosive substance by using an IMS system, in accordance with an embodiment of the present specification;

FIG. 3 is a graphical view of exemplary spectra that may be produced using the ITMS detection systems shown in FIGS. 1 and 2;

FIG. 4 is a graphical view of additional exemplary spectra that may be produced using the ITMS detection systems shown in FIGS. 1 and 2;

FIG. 5 is a schematic view of a TOF-ITMS detection system comprising a two-grid fragmenter, in accordance with an embodiment of the present specification;

FIG. 6 shows an exploded view of a first SIMION plot generated using a two-grid fragmenter at full maximum potential, in accordance with an embodiment of the present specification;

FIG. 7 shows an exploded view of a second SIMION plot generated using a two-grid fragmenter at full maximum potential, in accordance with an embodiment of the present specification;

FIG. 8 shows an exploded view of a third SIMION plot generated using the two-grid fragmenter at half-maximum of a sinusoidal waveform, in accordance with an embodiment of the present specification;

FIG. 9 is a schematic view of a TOF-ITMS detection system comprising a three-grid fragmenter, in accordance with an embodiment of the present specification;

FIG. 10 shows an enlarged view of a SIMION plot generated using a three-grid fragmenter, in accordance with an embodiment of the present specification;

FIG. 11 shows mobility spectra after ion peak isolation and fragmentation of chloride adduct of nitroglycerin using a two-grid fragmenter, in accordance with an embodiment of the present specification; and

FIG. 12 shows mobility spectra after ion peak isolation and fragmentation of chloride adduct of nitroglycerin using a three-grid fragmenter, in accordance with an embodiment of the present specification.

### DETAILED DESCRIPTION

In the following specification and the claims, a number of terms are referenced that have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise. In the description and claims of the application, each of the words “comprise” “include” and “have”, and forms thereof, are not necessarily limited to members in a list with which the words may be associated. It should be noted herein that any feature or component described in association with a specific embodiment may be used and implemented with any other embodiment unless clearly indicated otherwise.

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

It should be noted herein that while some reactions with negative ions may be termed “fragmentation” (i.e., hydrogen abstraction with loss of HCl), reactions with other explosives or materials may match other descriptions such as displacement and dissociation and not fragmentation in accordance with the formal definitions of mass spectrometry. Further, decomposition is a broadly applicable term which applies to the three ion processes (abstraction or fragmentation, displacement, and dissociation) and is reflective of the following core concept: a reactive stage where ion transformation can occur in a multi-stage IMS drift tube. Therefore, while any of the specific terms of fragmentation or abstraction, displacement, and dissociation may be used throughout this specification by way of providing exemplary use cases, it should be understood by those of ordinary skill in the art that the concept is broadly applicable to the core concept of decomposition as defined above.

In embodiments, the terms “sample of interest”, “materials of interest”, “composition of matter”, “composition of matter of interest”, and “explosive substance” may be used interchangeably and generally refer to a composition of matter that is the subject of investigation. In addition, the term “constituents in a sample” or “constituents” may be used to refer to any substance or combination of substances contained within a sample.

The embodiments described herein provide a cost-effective system and method for improving detection of materials of interest from an object or person. The systems and methods described herein use a detector having two sequentially arranged drift tubes which are separated by shutters facilitating ions of a user-selected, i.e., library-defined drift time to be introduced into the second drift tube whereas other ions of a different mobility are discarded as needed. The tandem reactive IMS and ITMS devices disclosed herein facilitate multiple opportunities to isolate ions of interest including ion separation and selection in the first drift tube, predetermined modification through fragmentation with a controllable electric field, and selected transmission into the second drift tube ultimately ending with specific identification of the ions. Regulation of the electric field strength and temperature analyte ions from one compound may dissociate and form dissociation products that can further be characterized, while ions from another compound may dissociate as well but form different products or may even not dissociate at all. As such, this dissociation information is important for providing another dimension of characterizing the mobility of ions by their stability and their dissociation products which provides additional confidence in the presence or absence of peaks that facilitates determining if an alarm could be generated or rejected. The results are more easily interpreted and provide more definitive information that can be used for the characterization of ions since only ions of a particular drift time are exposed to the high electric field and the associated fragmentation. Consequently substantially all dissociation products detected in the second drift tube originate from the ions selected from the first drift tube and subsequently fragmented. Moreover, the additional optional introduction of dopants facilitates further modification of the selected ions through chemical reactions with or without dissociation. As such, the systems described herein facilitate an additional level of selectivity that dramatically reduces the false alarm rate from that observed on traditional IMS systems. Therefore, the portable mobility spectrometers described herein facilitate substance analysis with higher confidence while maintaining atmospheric pressure operation.

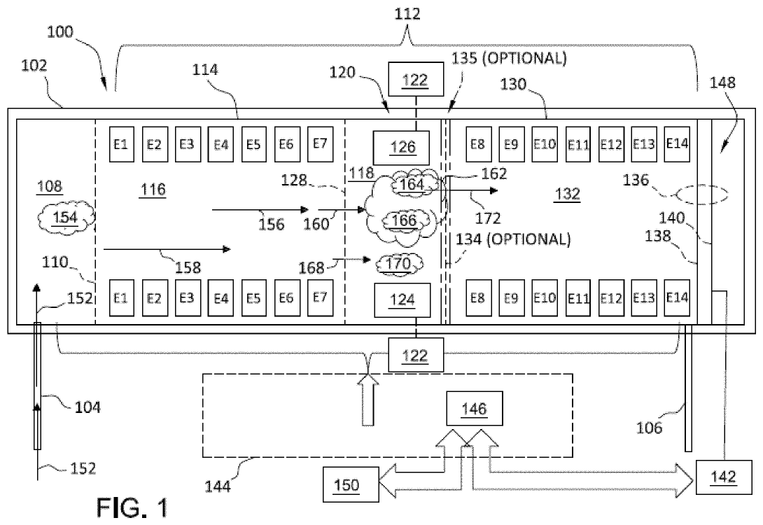

FIG. 1 is a schematic view of an exemplary time-of-flight (TOF) ion trap mobility spectrometer (ITMS) detection system 100 (not drawn to scale). ITMS detection system 100 includes a casing 102. ITMS detection system 100 also includes a gas inlet tube 104 and a gas outlet tube 106 coupled to casing 102. In the exemplary embodiment, casing 102 includes an ion trap reactor 108 coupled in flow communication with gas inlet tube 104. Ion trap reactor 108 includes an ionizing source material (not shown), e.g., and without limitation, nickel-63 (⁶³Ni) that emits low-energy beta-(β-) particles. Alternatively, any ionizing source or ionizing source material that enables operation of ITMS detection system 100 as described herein is used. ITMS detection system 100 further includes a retaining grid 110 extending over an outlet end of ion trap reactor 108.

Casing 102 further defines a tandem reactive dual drift tube and dual shutter configuration 112. Configuration 112 includes a first drift tube 114 defining a first drift field region 116 coupled in flow communication with ion trap reactor 108. Configuration 112 further includes a series of sequential annular electrodes E1, E2, E3, E4, E5, E6, and E7 extending about first drift field region 116. It should be noted herein that any number of electrodes may be used. Specifically, a minimum of two electrodes may be used to create the desired electrical gradient. There is no technical upper limit on the number of annular electrodes. Configuration 112 also includes a fragmentation region 118 at least partially defined by casing 102. Fragmentation region 118 facilitates predetermined modifications of ions received from first drift field region 116 through fragmentation with a controllable electric field generated by an electric field generation device 120 that includes a high-voltage radio-frequency (HV RF) unit 122 and electrodes 124 and 126 spaced from each other across the diameter of fragmentation region 118. Electrodes 124 and 126 are any devices that enable operation of ITMS detection system 100 through production of a strong electric field, such devices including, but not limited to, wire grids and other metal structures that generate sufficient field strength. Electric field generation device 120 generates electric fields of sufficient strengths and frequencies to modify ions therein (discussed further below).

Also, in the exemplary embodiment, configuration 112 further includes a first ion shutter 128 that at least partially defines first drift field region 116 and fragmentation region 118 when energized and facilitates flow communication between regions 116 and 118 when de-energized. In addition, configuration 112 includes a second drift tube 130 defining a second drift field region 132. Configuration 112 also includes a series of sequential annular electrodes E8, E9, E10, E11, E12, E13, and E14 extending about second drift field region 132. It should be noted herein that any number of electrodes may be used. Specifically, a minimum of two electrodes may be used to create the desired electrical gradient. There is no technical upper limit on the number of annular electrodes. Second drift field region 132 receives fragmented ions from fragmentation region 118. In some embodiments, configuration 112 further includes an optional second ion shutter 134 that at least partially defines second drift field region 132 and fragmentation region 118 when energized and facilitates flow communication between regions 118 and 132 when de-energized. In other embodiments, rather than second ion shutter 134, configuration 112 further includes an optional ion trap 135 similar in design, construction, and operation as ion trap reactor 108. Such ion trap 135 positioned between fragmentation region 118 and second drift field region 132 is configured to provide similar operational results as second ion shutter 134, i.e., release fragmented ions into second drift tube 130 as an alternative to using a shutter grid.

ITMS detection system 100 also includes an ion collector 136 that includes a collector shield grid, i.e., an aperture grid 138 and a collector electrode 140, e.g., a Faraday plate positioned just downstream of aperture grid 138. Collector electrode 140 is coupled to a spectral analysis device 142 that includes at least one current-to-voltage amplifier (not shown). ITMS detection system 100 further includes an ITMS control system 144 that includes a processing device 146. ITMS control system 144 is operatively coupled to ion trap reactor 108, retaining grid 110, sequential annular electrodes E1-E7, electric field generation devices 120, first ion shutter 128, second ion shutter 134 (if installed), second ion trap 135 (if installed), E8-E14, aperture grid 138, collector electrode 140, and spectral analysis device 142. Casing 102 also defines a collector region 148 coupled in flow communication with second drift field region 132 and gas outlet tube 106.

As used herein, the terms “processor” and “processing device” are not limited to just those integrated circuits referred to in the art as a computer, but broadly refers to a microcontroller, a microcomputer, a programmable logic controller (PLC), an application specific integrated circuit, and other programmable circuits, and these terms are used interchangeably herein. In the embodiments described herein, memory may include, but is not limited to, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Also, as used herein, the terms “software” and “firmware” are interchangeable, and include any computer program stored in memory for execution by personal computers, workstations, clients and servers.

Further, as used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Furthermore, as used herein, the term “real-time” refers to at least one of the time of occurrence of the associated events, the time of measurement and collection of predetermined data, the time to process the data, and the time of a system response to the events and the environment. In the embodiments described herein, these activities and events occur substantially instantaneously.

Processing device 146 and other processors (not shown) as described herein process information transmitted from a plurality of electrical and electronic devices that include, without limitation, spectral analysis device 142 and feedback devices (not shown) within ITMS detection system 100. Memory devices (not shown) and storage devices (discussed further below) store and transfer information and instructions to be executed by processing device 146. Such memory devices and storage devices can also be used to store and provide temporary variables, static (i.e., non-volatile and non-changing) information and instructions, or other intermediate information to processing device 146 during execution of instructions by processing device 146. Instructions that are executed include, but are not limited to, analysis of signals transmitted from spectral analysis device 142. The execution of sequences of instructions is not limited to any specific combination of hardware circuitry and software instructions. ITMS detection system 100 also includes a data storage device 150 coupled to processing device 146. Data storage device 140 stores the data generated by processing device 146, such data also retrievable through processing device 146.

In operation, a collection device (not shown) is coupled to gas inlet tube 104 and collects gaseous samples 152 from an object of interest (not shown). In some embodiments, rather than gaseous samples, inlet tube 104 channels particulate samples that are then vaporized to generate gaseous samples 152. Gaseous samples 152 are channeled to the diffuser region portion of ion trap reactor 108 for expanding gaseous samples 152 prior to entry into the ionization chamber portion of ion trap reactor 108. ⁶³Ni emits low-energy β-particles into ion trap reactor 108 and the β-particles ionize samples 152 while in the gaseous phase, thereby forming positive ions, negative ions, and free electrons. Ion trap reactor 108 is substantially a field-free region. Therefore, increasing a population density of the ions and electrons within ion trap reactor 108 is facilitated as a function of the flux of β-particles. As the ions are being generated in ion trap reactor 108 to increase the stored ion population 154 therein, retaining grid 110 is maintained at a slightly greater potential than the potential of ion trap reactor 108 to induce a retention field and reduce the potential for ion leakage from ion trap reactor 108. An electric field is then induced across ion trap reactor 108 and, depending on the polarity of the induced electric field, the positive ions or the negative ions are pulsed from ion trap reactor 108, through a high-voltage “kickout pulse”, and injected into first drift field region 116 through retaining grid 110. The ions of the opposite polarity are attracted to the walls of ion trap reactor 108 and are discharged there. The pulses are controlled through ITMS control system 144.

First drift field region 116 extends from retaining grid 110 to first ion shutter 128. For those systems that use negative ions, annular electrodes E1 through E7 are energized to voltages that are sequentially less negative between retaining grid 110 to first ion shutter 128, thereby inducing a constant positive field. Motion is induced in the negative ions from the initial pulse in ion trap reactor 108 and the ions are channeled through first drift field region 116 to first ion shutter 128. First ion shutter 128 induces a voltage that is less negative than the voltage of electrode E1 and is more negative than the voltage of electrode E7. ITMS control system 144 regulates the velocities of the ions injected from ion trap reactor 108 as they drift through first drift field region 116 toward first ion shutter 128 such that a selected portion 156 of ions injected into region 116 arrive at shutter 128 at a predetermined time, while a substantial amount of a non-selected portion 158 of ions arrive later due to the slower velocities or faster (not shown) due to the higher velocities. As such, ITMS control system 144 regulates the voltage of first ion shutter 128 for a first predetermined temporal period, thereby injecting a substantial amount 160 of the selected portion 156 of ions from first drift field region 116 into fragmentation region 118. A significant amount of the non-selected portion 158 of ions are not permitted to transit through first ion shutter 128 when the voltage is again adjusted by ITMS control system 144 to block such ions and molecules that are subsequently discarded, thereby reducing injection of the non-selected portion of ions and into fragmentation region 118. It should be noted herein that the predetermined time period is based on the individual ion and its mobility time, which is pre-programmed into the system. Therefore, the predetermined time is based on a prior understanding of the ions of interest and the known drift time of those ions of interest.

Also, in operation, ITMS control system 144 regulates electric field generation device 120 to modify the selected portion of ions, thereby generating predetermined ion fragments 162 within fragmentation region 118 through regulating a voltage and frequency of the controllable electric field generated between electrodes 124 and 126. The electric field dissociates a first portion of the selected portion 160 of ions injected into fragmentation region 118 into a first portion 164 of the predetermined ion fragments for further transmission to second field drift region 132. Fragmentation of selected ions 162 generates ion fragments 164 that have a different mobility from unmodified ions 166 that generate different peaks on the associated output spectrum. As such, fragmentation facilitates distinguishing between two different, but intermingled ion populations that would otherwise have similar mobilities, since the modified versions of these fragment ions 164 will have dissimilar mobilities from those of unmodified ions 166. In some embodiments, the operating frequency range is between 1 and 50 MHz. In some embodiments, the operating range of the electric field is between 5,000 and 30,000 V/cm.

Further, in operation, at least some of those ions 168 of the non-selected portion of ions 158 that made it into fragmentation region 118 are also modified to further distinguish the resultant dissociated non-selected ions 170 from the predetermined ion fragments 162 under consideration due to the different mobilities. The dissociated non-selected ions 170 are discarded. In alternative embodiments, none of the non-selected ions 158 are dissociated into fragments, but are discarded regardless.

Moreover, for those embodiments that include optional second ion shutter 134, in operation, the selected ion fragments under consideration 164 arrive at second ion shutter 134 at different times than most of the other ions, molecules, and fragments due to the different mobilities. As such, ITMS control system 144 regulates the voltage of second ion shutter 134 for a second predetermined temporal period, thereby injecting a substantial amount 172 of the selected portion 164 of the predetermined fragmented ions from fragmentation region 118 into second drift field region 132. A significant amount of the non-selected portion of ions 170 and fragments 166 are not permitted to transit through second ion shutter 134 when the voltage is again adjusted by ITMS control system 144 to block such ions 170 and fragments 166 that are subsequently discarded, thereby reducing injection of the non-selected portion of ions 158 into second drift field region 132.

Second drift field region 132 extends from a region between the downstream side of electrodes 124 and 126, or second ion shutter 134 (if installed), to collector region 148 defined by ion collector 136 and casing 102. Collector electrode 140 is positioned on the opposite side of drift field region 112 from electrodes 124 and 126, or second ion shutter 134 (if installed), and is held at, or near, a ground potential. For those systems that use negative ions, annular electrodes E8 through E14 are energized to voltages that are sequentially less negative than between electrodes 124 and 126, or second ion shutter 134 (if installed), to collector electrode 140, thereby inducing a constant positive field. For those embodiments that include optional ion trap 135 rather than optional second ion shutter 134, such ion trap 135 positioned between fragmentation region 118 and second drift field region 132 is configured to provide similar operational results as second ion shutter 134, i.e., release fragmented ions into second drift tube 130 as an alternative to using a shutter grid.

For such embodiments with second ion shutter 134, ITMS control system 144 regulates the voltage of second ion shutter 134 for a second predetermined temporal period, thereby injecting a substantial amount 172 of the selected portion 164 of fragmented ions from fragmentation region 118 into second drift field region 132. For those embodiments that include optional ion trap 135 rather than optional second ion shutter 134, such ion trap 135 positioned between fragmentation region 118 and second drift field region 132 is configured to provide similar operational results as second ion shutter 134, i.e., release fragmented ions into second drift tube 130 as an alternative to using a shutter grid. Motion is induced in the negative ions through the graduated potential along second field drift region 132. As such, ITMS control system 144 regulates the velocities of the selected portion 172 of the predetermined fragmented ions 164 injected from fragmentation region 118 as they drift through second drift field region 132 toward collector electrode 140. The selected portion 172 of the predetermined fragmented ions 164 injected into region 132 arrive at collector electrode 140 at a predetermined time, while any remaining non-selected ions 170 and ion fragments 166 are expected to arrive at a different drift time due to the different velocities. A significant amount of the non-selected portion of ions 170 and ion fragments 166 are not permitted to transit through second ion shutter 134 (or ion trap 135) when the voltage is again adjusted by ITMS control system 144 to block non-selected ions 170 and ion fragments 166 that are subsequently discarded, thereby reducing injection of the non-selected 170 portion of ions and ion fragments 166 into second field drift region 132. It should be noted herein that the predetermined time period is based on the individual ion and its mobility time, which is pre-programmed into the system. Therefore, the predetermined time is based on a prior understanding of the ions of interest and the known drift time of those ions of interest.

Therefore, in operation, with, or without second ion shutter 134 (and, similarly, with or without ion trap 135), the selected portion 172 of the predetermined fragmented ions 164 drift through second field drift region 132 to collector electrode 140 through aperture grid 138. Aperture grid 138 induces a voltage that is less negative that the voltage of electrode E8 and is more negative than the voltage of collector electrode 140 that is maintained at substantially ground potential. Signals representative of the ion population at collector electrode 140 are generated and transmitted to spectral analysis device 142 to determine the constituents in collected gas samples 152, and a detection spectrum representative of the ion or fragment ions detected at collector electrode 140 through spectral analysis device 142 coupled to collector electrode 140. In some embodiments, electrodes E1-E7, the first ion shutter, the second ion shutter, and electrodes E8-E14 have an electric field operating range of between 10 to 1000 V/cm.

The exemplary embodiment as described above is directed to an ITMS detection system 100 configured to use negative ions. However, in some embodiments, ITMS detection system 100 is configured to use positive ions. In such embodiments, the electric field induced across ion trap reactor 108 has a polarity to “kick out” the positive ions rather than the negative ions such that the positive ions are pulsed from ion trap reactor 108 through the high-voltage “kickout pulse”, and injected into first drift field region 116 through retaining grid 110. The ions of the opposite polarity are attracted to the walls of ion trap reactor 108 and are discharged there. Motion is induced in the positive ions from the initial pulse in ion trap reactor 108. Also, in such circumstances, annular electrodes E1 through E7 are energized to voltages that are sequentially less positive between retaining grid 110 to first ion shutter 128 to facilitate inducing motion in the positive ions such that the ions are channeled through first drift field region 116 to first ion shutter 128. First ion shutter 128 induces a voltage that is less positive than the voltage of electrode E1 and is more positive than the voltage of electrode E7. The remainder of ITMS detection system 100 is further configured for positive ions rather than negative ions and operation thereof is executed accordingly.

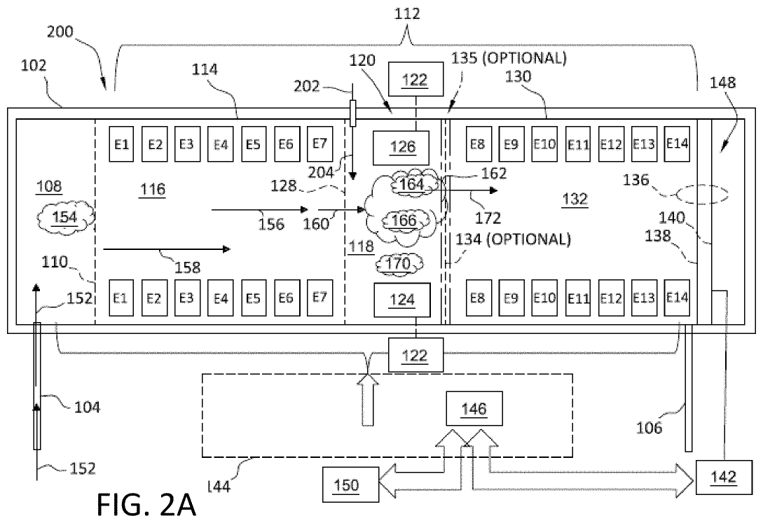

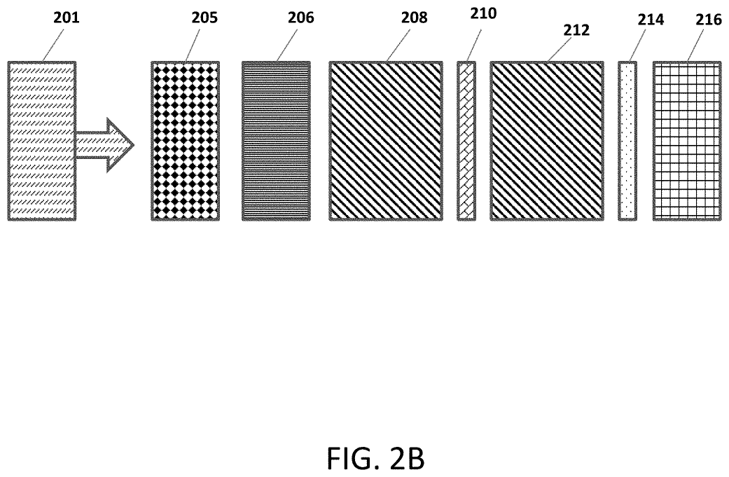

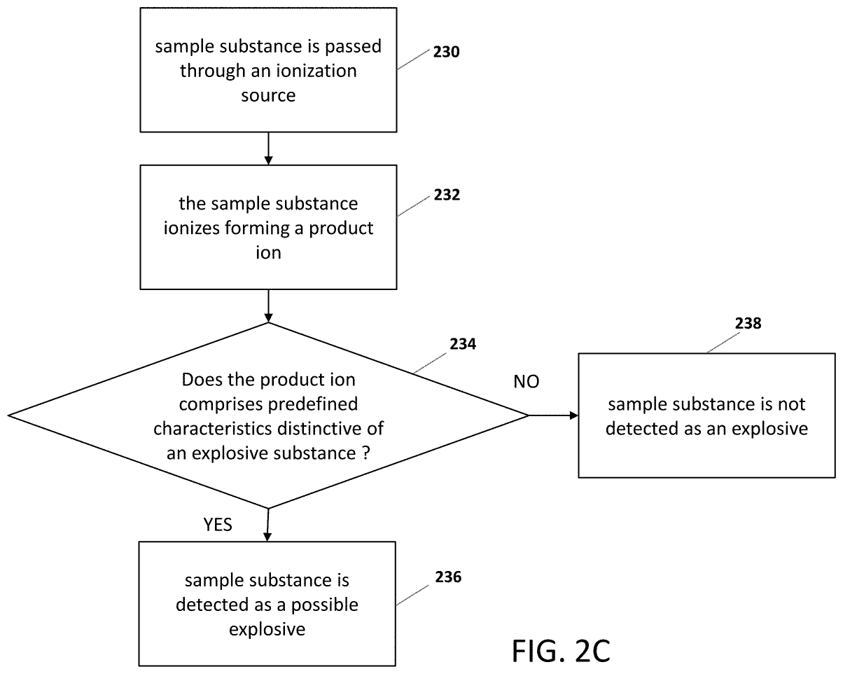

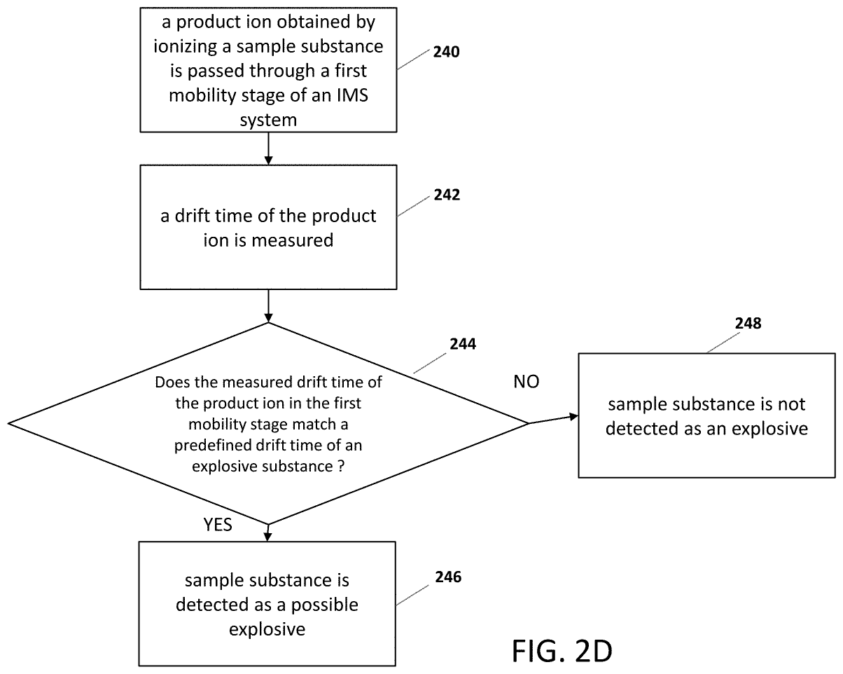

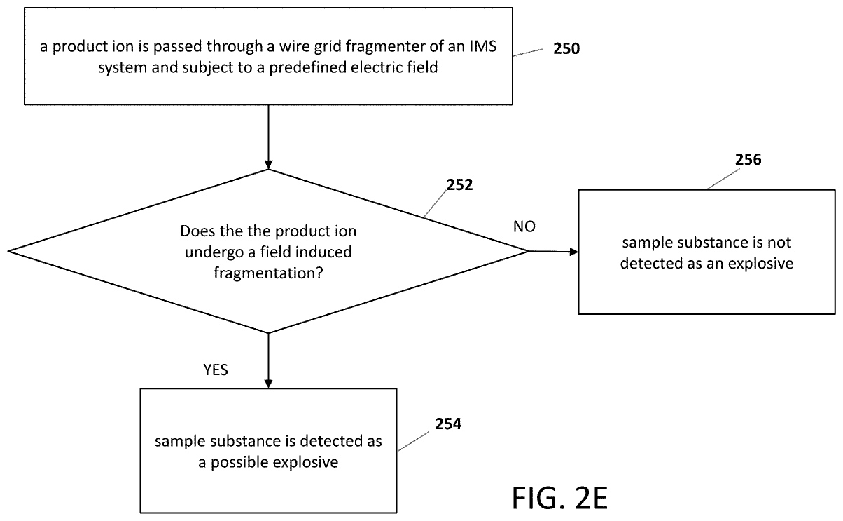

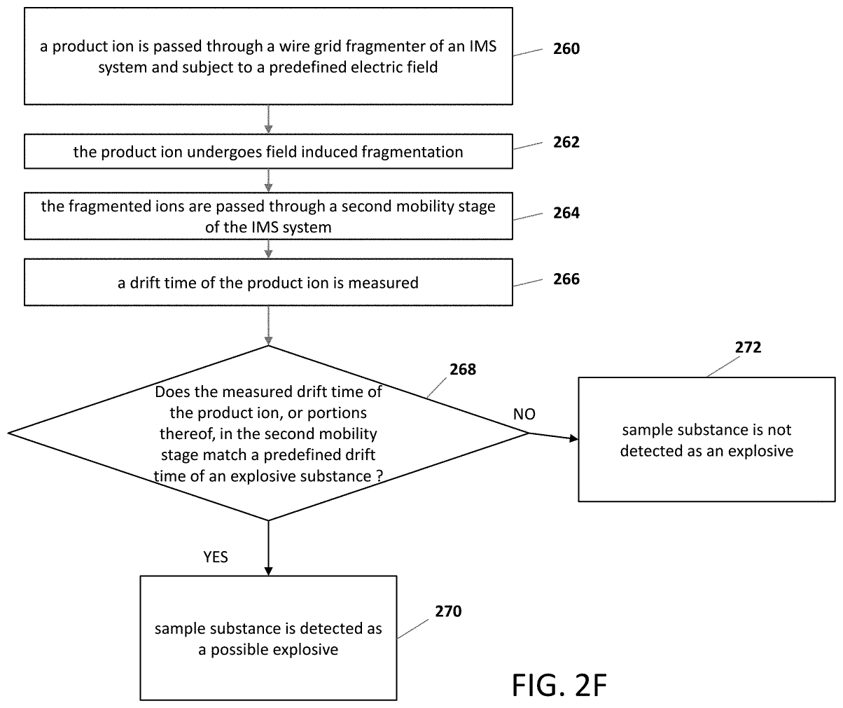

FIG. 2A is a schematic view of an alternative ion trap mobility spectrometer (ITMS) detection system 200 (not drawn to scale). System 200 is similar to system 100 (shown in FIG. 1) with the difference that system 200 includes a dopant injection system 202 coupled in flow communication with fragmentation region 118. Some dopants further enhance the specificity of identification of substances, for example, and without limitation, some typical dopants used in trace detection of explosives are chlorinated compounds, e.g., in a negative ion mode, and without limitation, dichloromethane, hexachloroethane, and chloroform, and, in positive ion modes, and without limitation, acetone and ammonia-based compounds, e.g., ammonium carbamate, and anhydrous ammonia. Therefore, in operation of system 200, a dopant 204 is injected into fragmentation region 118 and at least a portion of injected dopant 204 is mixed with the selected portion of ions 160 from first drift field region 116. Operation of system 200 is similar to that of system 100 as described above, with the primary difference of the dopant altering the population of predetermined fragmented ions 164 and 172 with constituents including, without limitation, adducts (not shown).

TOF ion mobility spectrometer (IMS) detection systems (not shown) are similar to ITMS detection systems 100 and 200 with one difference of the IMS detections systems is that they do not include ion trap features through a retaining grid that is maintained at a relatively constant voltage to trap the ions in the ionization chamber. Rather, IMS detection systems include an ion gate device (sometimes referred to as an ion shutter), e.g., a Bradbury-Nielsen gate. Similar to retaining grid 110 of systems 100 and 200, as the ions are being generated in the IMS ionization region to increase the ion current therein, the ion gate device is maintained at a relative voltage great enough to substantially prevent ion current transmitting into the adjacent drift region. The relative voltage difference between the ion gate device is then temporarily removed and the stored ions are pulsed from the ionization region into the drift region through the ion gate device. The temporal period of gate de-energization is predetermined. The voltage applied of the ion gate device is then re-established, thereby substantially halting ion entry from the ionization region into the drift region. Therefore, rather than pulsing the ions through a consistently energized retaining grid as is done for ITMS systems 100 and 200, in the IMS systems the ion gate is temporarily de-energized.

In various embodiments, in an IMS analyzer, a sample substance is ionized in an ionization source, the resultant ions are characterized in a first part of a drift tube of the IMS analyzer, and the ions are separated according to their mobility characteristics. Next, selected ions of interest are fragmented in a reactive stage, characterized in a second part of the drift tube and detected by an ion detector. In various embodiments, false positive rates in an ion mobility spectrometer (IMS) can be reduced with an improved reactive region that is configured to detect trace levels of compounds of interest, such as explosives, narcotics, chemical warfare agents, or toxic industrial chemicals. In an embodiment, by using an IMS similar to the ITMS described in FIG. 1 and FIG. 2A, ions having a predefined mobility are passed through a second ion shutter for subjecting said ions to a strong electric field (>10,000 V/cm) causing ion reactions, either for the compound of interest or an interference.

In the instance of field fragmentation of an ion of interest, e.g. an ion of an explosive, a positive response for the explosive preferably meet four criteria of selection. FIG. 2B is a block diagram illustrating the criteria to be met by a sample substance for positive detection as an explosive by using IMS system, in accordance with an embodiment of the present specification. As shown in FIG. 2B a sample substance 201 is passed through an ionization source 205 of the IMS system, wherein the sample substance 201 ionizes, forming a product ion 206 distinctive of an explosive molecule. In an embodiment the formed ion is analyzed by a processor coupled with the IMS system to determine if the ion comprises predefined characteristics distinctive of an explosive as recorded in a database coupled with the processor.

The second condition that the sample substance should meet to be identified as an explosive is that the product ion 206 preferably exhibits a first predefined drift time corresponding to the explosive, in a first mobility stage 208. As a third criterion, the product ion of interest 206 should preferably fragment under field induced decomposition at a predefined electric field in a wire grid fragmenter 210 to be identified as an explosive. The fourth condition that the sample substance preferably meets to be identified as an explosive is that the fragmented ion must exhibit a second predefined drift time corresponding to the explosive ion in a second mobility stage 212. The explosive ion is then detected by a detector 214 to obtain positive identification data 216 of the sample ion 201 as a possibly explosive ion.

FIG. 2C is a flowchart illustrating a first criterion for a sample substance to be identified as an explosive substance by using an IMS system, in accordance with an embodiment of the present specification. At step 230 the sample substance is passed through an ionization source of the IMS system. At step 232, the sample substance ionizes forming a product ion. At step 234 it is determined if the product ion comprises predefined characteristics distinctive of an explosive substance. In some embodiments, the predefined characteristics include the drift time (i.e., the mobility coefficient); the explosive would need to form either positive or negative ions in a given chemical environment (dopant), which is based on the type of explosive and ion chemistry associated with it; and based on the volatility of the explosive, a certain desorption temperature would be needed in order to volatilize the explosive and transfer the molecules into the detector. In an embodiment the formed ion is analyzed by a processor coupled with the IMS system to determine if the ion comprises predefined characteristics distinctive of an explosive as recorded in a database coupled with the processor. At step 236 if the product ion comprises predefined characteristics distinctive of an explosive substance the sample substance is detected as a possible explosive; while if the product ion does not comprise predefined characteristics distinctive of an explosive substance the sample substance is not detected as a possible at step 238.

FIG. 2D is a flowchart illustrating a second criterion for a sample substance to be identified as an explosive substance by using an IMS system, in accordance with an embodiment of the present specification. At step 240 a product ion obtained by ionizing a sample substance is passed through a first mobility stage of the IMS system. At step 242, a drift time of the product ion is measured. At step 244 it is determined if the measured drift time of the product ion in the first mobility stage matches a predefined drift time of an explosive substance. In an embodiment the measured drift time is compared by a processor coupled with the IMS system against predefined drift times distinctive of an explosive as recorded in a database coupled with the processor. At step 246 if the measured drift time of the product ion in the first mobility stage matches a predefined drift time of an explosive substance, the sample substance is detected as a possible explosive, while if the measured drift time of the product ion in the first mobility stage does not match a predefined drift time of an explosive substance, the sample substance is not detected as a possible explosive at step 248.

FIG. 2E is a flowchart illustrating a third criterion for a sample substance to be identified as an explosive substance by using an IMS system, in accordance with an embodiment of the present specification. At step 250 a product ion obtained by ionizing a sample substance is passed through a wire grid fragmenter of the IMS system, wherein the product ion is subject to a predefined electric field. At step 252 it is determined if it is fragmented under the predefined electric field. In an embodiment a processor coupled with the IMS system is used for providing predefined voltage values that cause fragmentation of explosive ions within the wire grid fragmenter. At step 254 if the product ion undergoes field induced fragmentation under the predefined electric field, the sample substance is detected as a possible explosive; while if the product ion does not fragment under at the predefined electric field, the sample substance is not detected as a possible explosive at step 256.

FIG. 2F is a flowchart illustrating a fourth criterion for a sample substance to be identified as an explosive substance by using an IMS system, in accordance with an embodiment of the present specification. At step 260 a product ion obtained by ionizing a sample substance is passed through a wire grid fragmenter of the IMS system, wherein the product ion is subject to a predefined electric field. At step 262 the product ion undergoes field induced fragmentation. At step 264, the fragmented ions are passed through a second mobility stage of the IMS system. At step 266, a drift time of the product ion is measured. At step 268 it is determined if the measured drift time of the product ion in the second mobility stage matches a predefined drift time of an explosive substance. In an embodiment the measured drift time is compared by a processor coupled with the IMS system against predefined drift times distinctive of an explosive as recorded in a database coupled with the processor. At step 270 if the measured drift time of the product ion in the second mobility stage matches a predefined drift time of an explosive substance, the sample substance is detected as a possible explosive; while if the measured drift time of the product ion in the second mobility stage does not match a predefined drift time of an explosive substance, the sample substance is not detected as a possible explosive at step 272. Finally, if a substance satisfies each of the aforementioned four criterion, it is identified as an actual explosive or target substance of interest, not merely a possible or candidate explosive or target substance of interest.

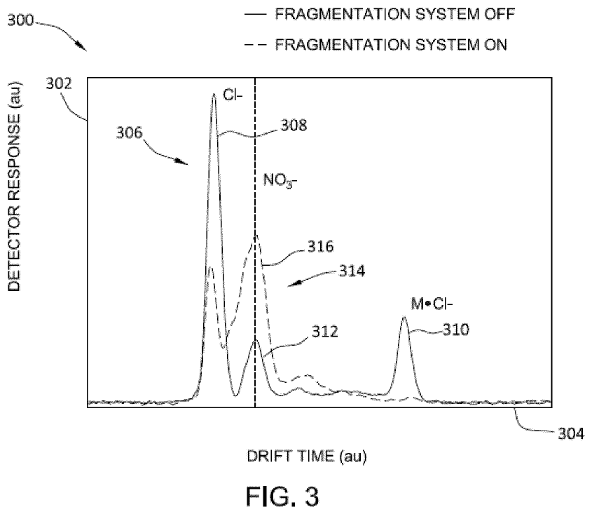

FIG. 3 is a graphical view, i.e., graph 300 of exemplary spectra that may be produced using ITMS detection systems 100 and 200 (shown in FIGS. 1 and 2, respectively). Graph 300 includes a y-axis 302 representative of ion intensity, i.e., detector response in arbitrary units (au). Also, graph 300 includes an x-axis 304 representative of drift time in arbitrary units (au). In the exemplary embodiment, a sample of ethylene glycol dinitrate (EGDN) [C2H4(ONO2)2], a common constituent of explosive devices, is introduced into IMS detection system 200, system 200 including tandem reactive drift tube configuration 112 (shown in FIGS. 1 and 2).

Graph 300 includes a first trace 306 representing a spectral analysis of the EGDN sample with the fragmentation system off, i.e., electric field generation device 120 in fragmentation region 118 (both shown in FIGS. 1 and 2) removed from service. First trace 306 includes a chloride ion (Cl⁻) peak 308 and a M·Cl⁻ adduct peak 310. While peak 308 is a dopant peak, peak 310 may indicate the presence of EGDN (EGDN*Cl⁻). A peak 312 may indicate the presence of trace amounts of NO₃⁻.

Graph 300 also includes a second trace 314 representing a spectral analysis of the EGDN sample with the fragmentation system on, i.e., electric field generation device 120 in fragmentation region 118 placed in service. Second trace 314 includes a nitrate (NO₃⁻) peak 316 as a result of the decomposition of EGDN, such peak indicative of the presence of EGDN. Notably, M·Cl⁻ adduct peak 310 is not found with second trace 314 since the M·Cl⁻ ions were decomposed using the fragmentation system. The peak just to the left of nitrate peak 316 is at least partially due to some additional Cl⁻ from peak 308. Therefore, use of the fragmentation system during sample analysis in conjunction with the remainder of the tandem reactive dual drift tube and dual shutter configuration 112 significantly improves the sample analyses for substances of interest, such as EGDN.

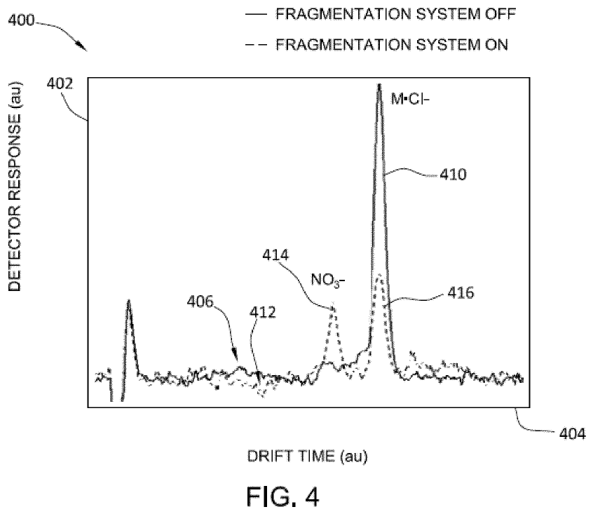

FIG. 4 is another graphical view, i.e., graph 400 of exemplary spectra that may be produced using ITMS detection systems 100 and 200 (shown in FIGS. 1 and 2, respectively). Graph 400 includes a y-axis 402 representative of ion intensity, i.e., detector response in arbitrary units (au). Also, graph 400 includes an x-axis 404 representative of drift time in arbitrary units (au). In the exemplary embodiment, a sample of ethylene glycol dinitrate (EGDN) [C₂H₄(ONO₂)₂], a common constituent of explosive devices, is introduced into IMS detection system 200, system 200 including tandem reactive drift tube configuration 112 (shown in FIGS. 1 and 2). Only the analyte ions of EGDN (shown as 310 in FIG. 3), however, are transferred through the first shutter 128 into the second drift tube 130 defining the second drift region 132 whereas all other ions of different mobilities are excluded from passing the shutter.

Graph 400 includes a first trace 406 representing a spectral analysis of the analyte ions of the EGDN sample with the fragmentation system off, i.e., electric field generation device 120 in fragmentation region 118 (both shown in FIGS. 1 and 2) removed from service. First trace 406 includes an M·Cl⁻ adduct peak 410, peak 410 may indicate the presence of EGDN (EGDN*Cl⁻). No other peaks such as the dopant peak previously shown as 308 in FIG. 3 are detected in the spectrum 406 displayed in FIG. 4.

Graph 400 also includes a second trace 412 representing a spectral analysis of the analyte ions (M·Cl)⁻ of the EGDN sample with the fragmentation system on, i.e., electric field generation device 120 in fragmentation region 118 placed in service. Second trace 412 includes a nitrate (NO₃⁻) peak 414 as a result of the decomposition of the analyte ions of EGDN, such peak indicative of the presence of EGDN. Notably, this peak was not present when the fragmentation system was off. Moreover, the intensity of a M·Cl⁻ adduct peak 416 is much lower with second trace 412 compared to the intensity of 410 since the M·Cl⁻ ions were decomposed using the fragmentation system. Therefore, use of the fragmentation system during sample analysis in conjunction with the remainder of the tandem reactive dual drift tube and dual shutter configuration 112 significantly improves the sample analyses for substances of interest, such as EGDN.

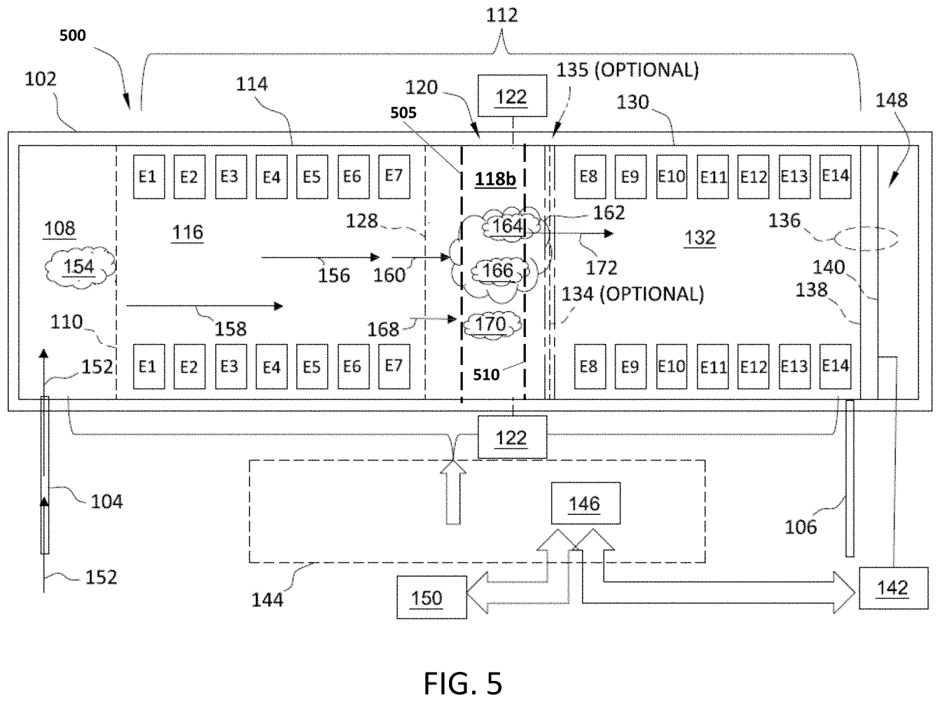

FIG. 5 is a schematic view of an alternate embodiment of the TOF-ITMS detection system 100 shown in FIG. 1 and system 200 shown in FIG. 2A, comprising a two-grid fragmenter, in accordance with an embodiment of the present specification. In this alternate embodiment, fragmentation region 118b (shown as 118 in FIGS. 1 and 2) is defined by a two-grid fragmenter comprising first wire grid 505 and second wire grid 510 spaced from each other by a distance ranging from 10 μm to 2 mm along a longitudinal axis of the fragmentation region 118b. The fragmentation region 118b facilitates predetermined modifications of ions received from first drift field region 116 via fragmentation with a controllable electric field generated by the electric field generation device 120 that includes the high-voltage radio-frequency (HV RF) unit 122 and the two-grid fragmenter. The first wire grid 505 and second wire grid 510 enable operation of the detection system 500 through production of a strong electric field in a range of 20 to 30,000 V/cm. Persons of ordinary skill in the art would understand that the operation of the detection system 500 is similar to that of the detection systems 100, 200.

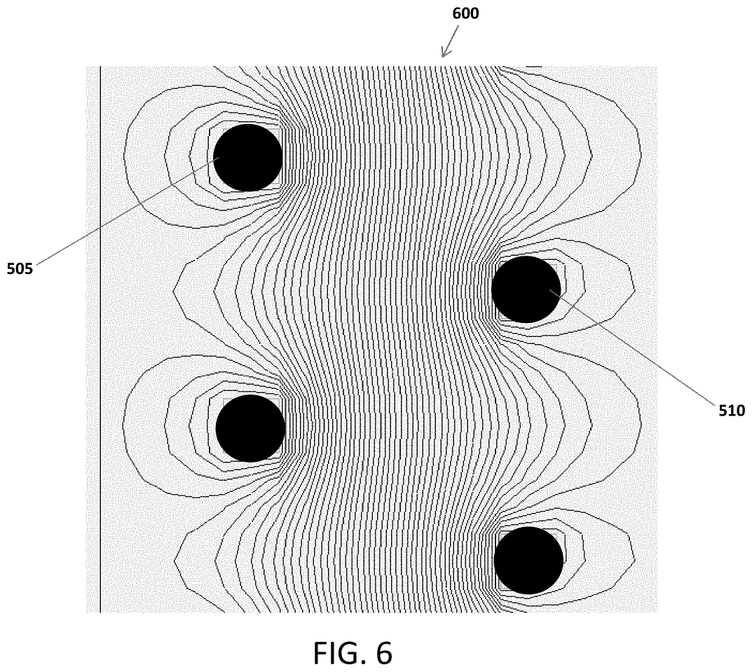

The two-grid fragmenter configuration of the detection system 500 as well as the two electrode-based (124, 126) configuration of the detection systems 100, 200 allow ions of interest to be fragmented between the first drift field region 116 and second drift field region 132. FIG. 6 shows an enlarged view of a SIMION plot 600 of a model of potentials within the two grid structures 505, 510 at full maximum potential.

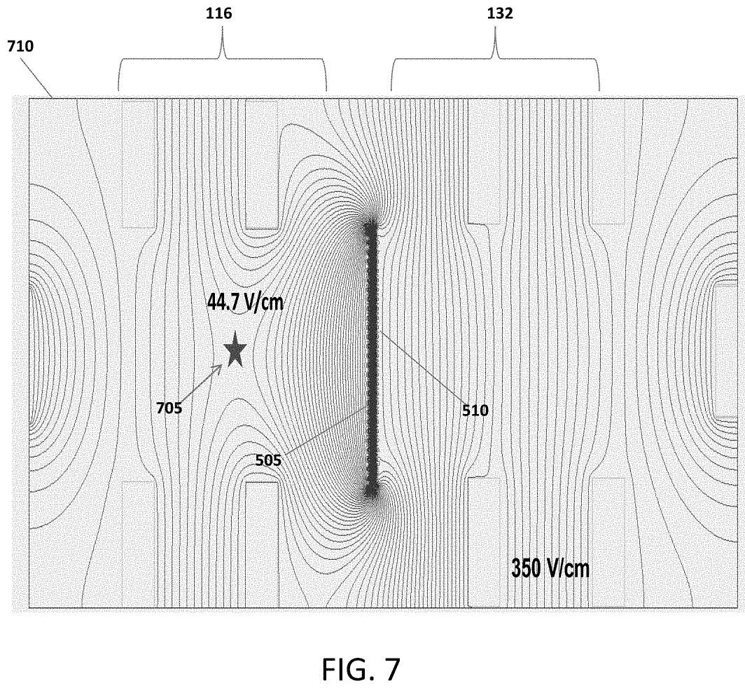

As shown in FIG. 7, when SIMION modeling was expanded to include an enlarged view of the drift field regions 116, 132 equipped with the two-grid fragmenter having first wire grid 505 and second wire grid 510, the existence of a distortion region 705 in the potential contour was observed. The distortion region 705, also referred to hereinafter as the “saddle”, is up-field from the two-grid fragmenter. The distortion region 705 scatters ions causing fewer ions (and thereby a decreased signal) to be transferred into the second drift field region 132. It should be noted that there are divergent contours as ions enter the saddle 705 slightly off-axis. Contours become convergent for any ions surviving passage through the saddle 705. Few ions emerge from the saddle volume 705 and most are drained to the sides of the drift tube 710 at an extreme maximum of a sinusoidal waveform applied to the first, or up-field, grid 505 in the two-grid fragmenter.

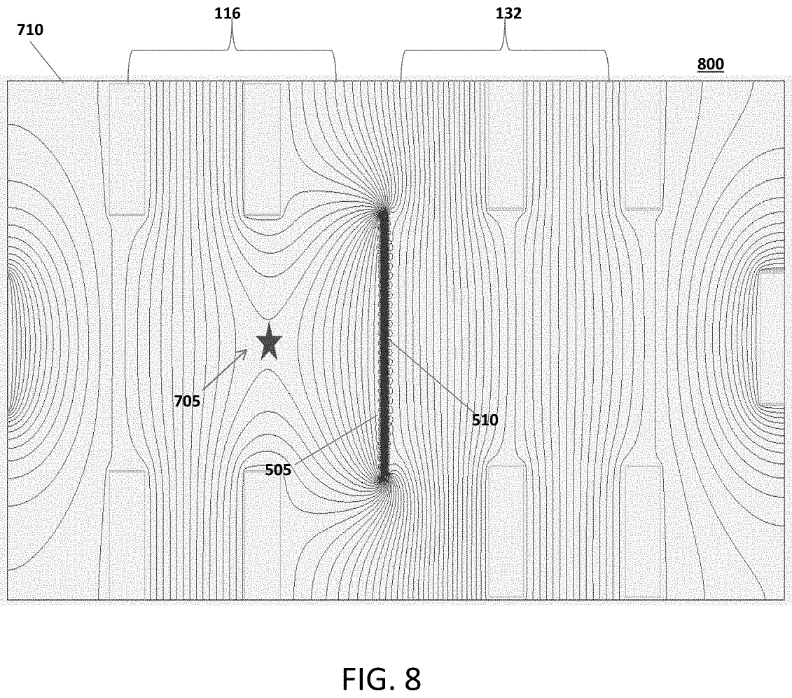

FIG. 8 shows a SIMION plot 800 of potential contours at half maximum of the sinusoidal waveform using the two-grid fragmenter, in accordance with an embodiment of the present specification. As can be observed from the plot 800, subtle changes occur with the contours and the saddle 705 as the waveform amplitude changes with lessened potential gradients toward the side of the drift tube 710 while the saddle 705 is shifted towards the first wire grid 505 and second wire grid 510 as compared to the position of the saddle 705 of FIG. 7. The decrease in density of potential contours provides a reduction in ion losses to the side of the drift tube 710. This change of pattern with respect to contours continues as the waveform amplitude decreases and significantly, there is no visible saddle when the waveform amplitude swings to an opposite extreme. Thus, ion losses in flux through the drift tube are dependent on waveform amplitude. When the area of the waveform is based on this amplitude and half maximum, the loss in ion flux through the drift tube can be estimated as approximately 30%. The two-grid fragmenter configuration described above, however, does not optimally allow for control of the amount of fragmentation, the fragmentation electronics, and/or the range of field energies. The amount of fragmentation that can be achieved using a two-grid fragmenter is in the range of 10% to 50%. The loss in ion transmission is on the order of 30% to 50% in using a two-grid fragmenter.

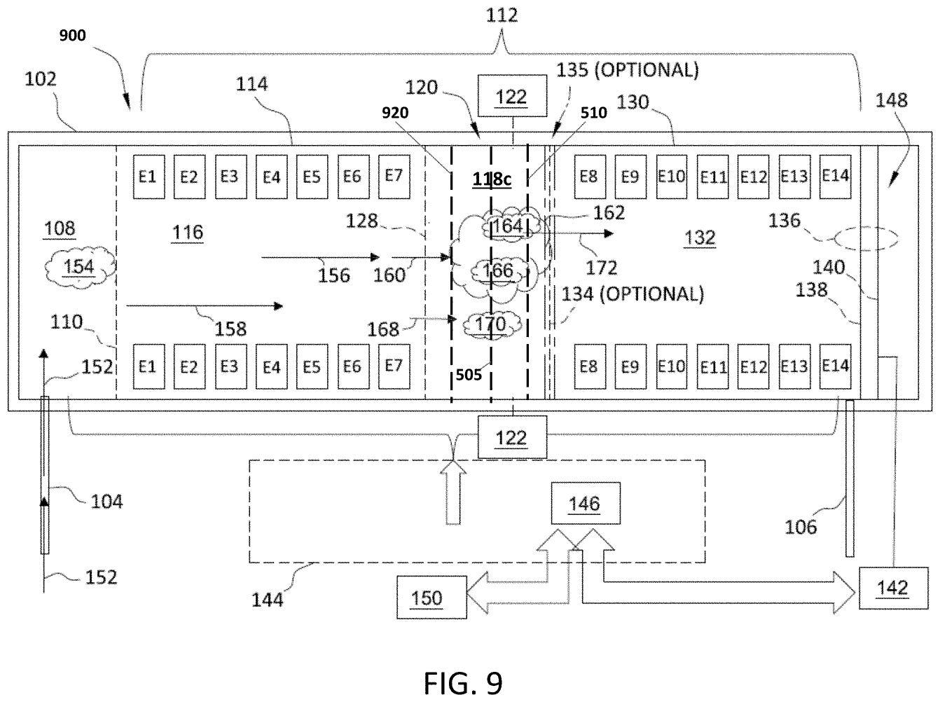

In accordance with yet another aspect of the present specification, the addition of a third grid to the two-grid fragmenter increases both the ion transmission and the fragmentation efficiency. FIG. 9 is a schematic view of a TOF-ITMS detection system 900 comprising a three-grid fragmenter, in accordance with an embodiment of the present specification. The detection system 900 is provides an improvement over the detection system 500 (and the detection systems 100, 200) in that the fragmentation region 118c is defined by a three-grid fragmenter comprising a first wire grid 905, a second wire grid 910, and a third wire grid 920 spaced from each other along a longitudinal axis 915 of the fragmentation region 118c. In an embodiment, first wire grid 905 and second wire grid 910 are spaced from each other by a distance ranging from 10 μm to 2 mm. In an embodiment, the second wire grid 910 and the third wire grid 920 are spaced from each other by a distance ranging from 0.05 mm to 10 mm, and preferably ranging from 0.1 mm to 8 mm along a longitudinal axis of the fragmentation region 118c. In an embodiment, the third wire grid 920 is positioned upstream with reference to the first wire grid 905 and spaced by a distance ‘d.’ from the first wire grid 905. In various embodiments, the distances between the auxiliary grid and the wires for fragmentation are defined in multiples of 1 to 10. The distance between the wire grids 905, 910 and 920 is a primary driver of the fragmentation efficiency of the grid fragmenter. It should be noted that the voltage needed for fragmentation is impacted by the distance between the wire grids; thus, if there is a shorter distance between the wire grids, a lower voltage may be sufficient. Therefore, in one embodiment, the invention is directed to decreasing a voltage required by shortening the distance between the wire grids. In another embodiment, the invention is directed to modifying a fragmentation efficiency of the device by lengthening or shortening the distance between the wire grids.

Thus, in one embodiment, ion mobility spectrometer (IMS) detection systems disclosed herein comprise at least 3 grids, positioned in a fragmentation region, where a distance from the most upstream of the at least 3 grids to the most downstream of the at least 3 grids is in a range of 0.1 mm to 8 mm, wherein one of the at least 3 grids is positioned in between the most upstream and most downstream grids, and wherein a degree of fragmentation in the fragmentation region is greater than 50% with a loss in ion transmission being less than 50% and preferably less than 30%. One of ordinary skill in the art would appreciate that the other features, limitations, and elements described herein are equally applicable to the above-described embodiment.

TOF ion mobility spectrometer (IMS) detection systems (not shown) are similar to ITMS detection systems 100, 200, 500 and 900 with one difference of the IMS detections systems is that they do not include ion trap features through a retaining grid that is maintained at a relatively constant voltage to trap the ions in the ionization chamber. Rather, IMS detection systems include an ion gate device (sometimes referred to as an ion shutter), e.g., a Bradbury-Nielsen gate. Similar to retaining grid 110 of systems 100, 200, 500 and 900 as the ions are being generated in the IMS ionization region to increase the ion current therein, the ion gate device is maintained at a relative voltage great enough to substantially prevent ion current transmitting into the adjacent drift region. The relative voltage difference between the ion gate device is then temporarily removed and the stored ions are pulsed from the ionization region into the drift region through the ion gate device. The temporal period of gate de-energization is predetermined. The voltage applied of the ion gate device is then re-established, thereby substantially halting ion entry from the ionization region into the drift region. Therefore, rather than pulsing the ions through a consistently energized retaining grid as is done for ITMS systems 100 and 200, in the IMS systems the ion gate is temporarily de-energized.

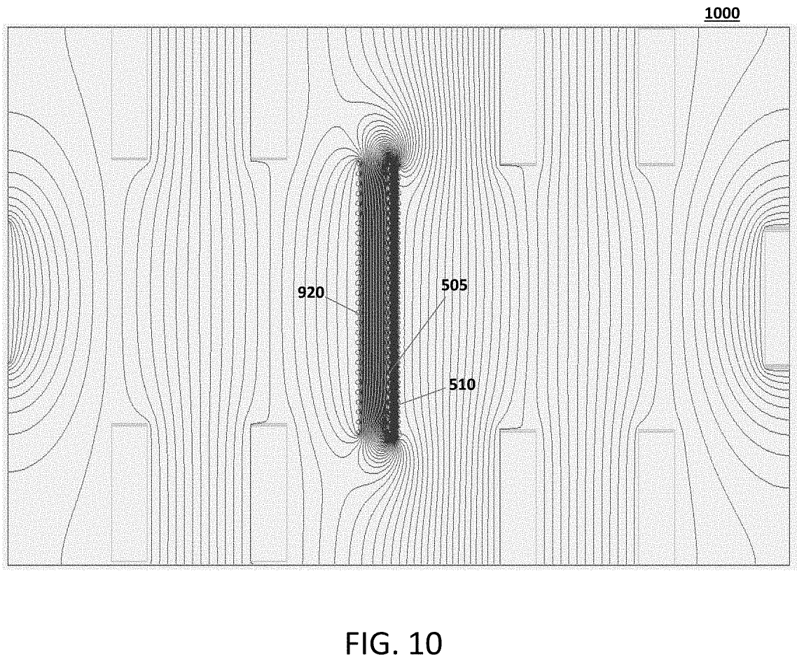

FIG. 10 shows a SIMION plot 1000 of potential contours when 2550 V (1050 DC voltage plus sinusoidal RF voltage) is applied to the first wire grid 505 while 1155 V is applied to the third wire grid 920 of the detection system 900 of FIG. 9, in accordance with an embodiment of the present specification. As can be observed from plot 1000, addition of the third wire grid 920 eliminates the saddle 705 of FIG. 7 and FIG. 8 that may be associated with the two-grid fragmenter configuration. As a result of addition of the third grid 920, the detection system 900 of FIG. 9 has an ion transmission during fragmentation, seen in ion peak area, of about 90% of original peak intensity. Additional advantages of the three-grid fragmenter based detection system 900 are improved control and effectiveness of the wire grids 505, 510, 920 (FIG. 9).

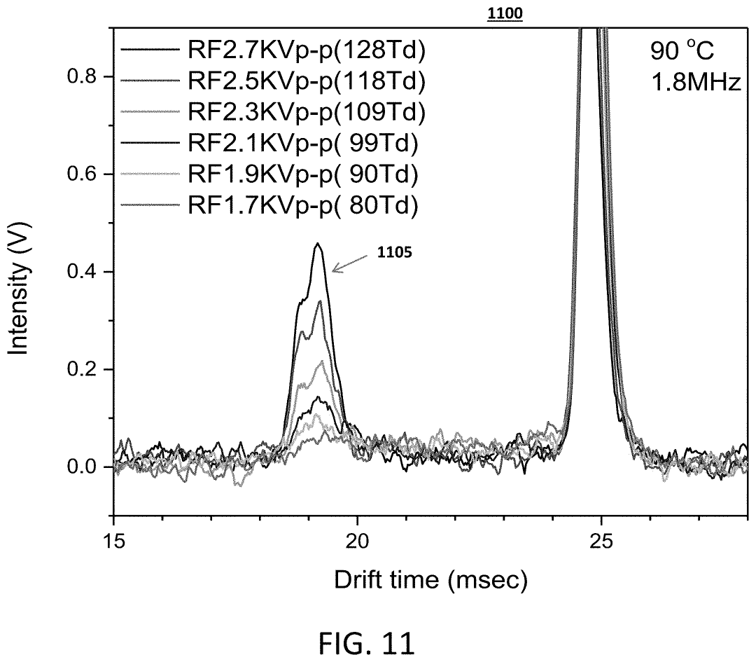

FIG. 11 shows mobility spectra 1100 after ion peak isolation and fragmentation of chloride adduct of nitroglycerin (having about 24.8 milliseconds uncorrected drift time) using the two-grid fragmenter of the detection system 500 (FIG. 5), in accordance with an embodiment of the present specification. FIG. 11 shows formation of a fragment ion 1105, which is a nitrate ion NO₃⁻ from the chloride adduct of nitroglycerin where a maximum field of 128 Td produces approximately 30% efficiency conversion of product ion to fragment ions at 90° C.

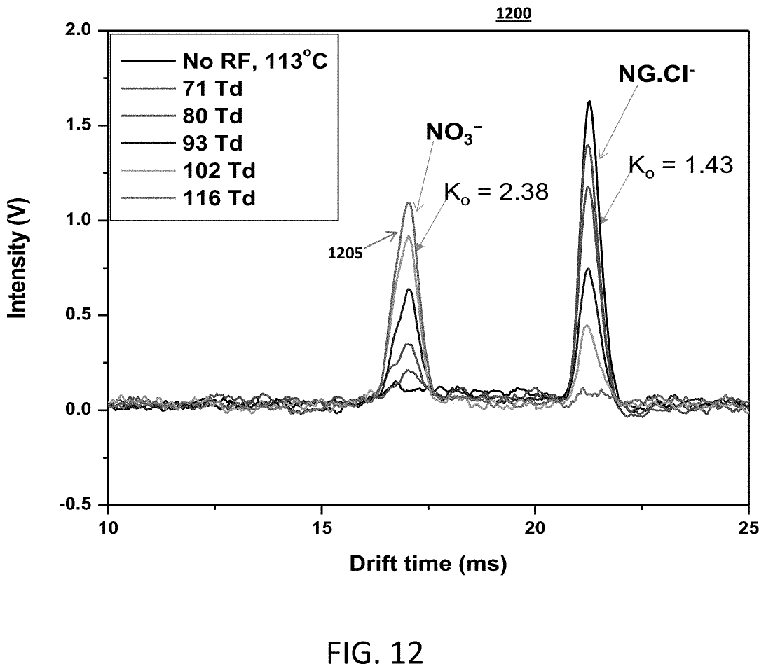

FIG. 12 shows mobility spectra 1200 after ion peak isolation and fragmentation of chloride adduct of nitroglycerin (having about 22 milliseconds uncorrected drift time) using the three-grid fragmenter of the detection system 900 (FIG. 9), in accordance with an embodiment of the present specification. In contrast to the spectra 1100 of FIG. 11, the spectra 1200 illustrates that the amount of fragmentation with the three-grid fragmenter is greater than 90% (see trace 1205, which is a nitrate ion NO₃) at 116 Td. This is accompanied by increased stability and control of the RF waveform.

ITMS detection systems 100, 200, 500 and 900 (shown in FIGS. 1, 2, 5 and 9, respectively) facilitate ion fragmentation that further facilitates identifying chemical families primarily based on the way the analyte ions fragment. In general, ions in a gas phase at ambient pressure are not as robust as molecules in air at ambient pressure, i.e., the electrostatic charge on the ions increase the vulnerability of the bonds in the ion to weakening. Also, in general, increasing the thermal energy of the ions increases the vibratory motion, thereby further weakening the covalent bonds of the ions and, in cooperation with destabilizing effects of the ionic charge, rendering the bonds unstable until covalent bond cleavage, i.e., ion fragmentation is achieved. One method of increasing the temperature of the gaseous ions is through adding thermal energy to the gas by increasing the gas temperature through a heating device (not shown) to preheat the gas prior to injection into systems 100 and 200. Another method includes using the electric fields induced as described above to rapidly increase the kinetic energy of the ions that translates into increasing the thermal energy, and as such, the vibration of the ions. Use of the electric fields already present facilitates weakening of the ion bonds at much lower temperatures. Increasing the strength of the electric fields accelerates ion fragmentation. Because substances of a given family have similar molecular structures and similar bonding and ionic characteristics within the core structure of the molecule, such ions therefore tend to break into pieces corresponding to the characteristics of such substance(s). As such, further fragmentation of the ions into selected and known ion fragments further facilitates identifying chemical families.

The portable, atmospheric pressure, tandem reactive IMS devices described herein provide cost-effective systems and methods for improving detection of materials of interest from an object or person. The systems and methods described herein use a detector having two sequentially arranged drift tubes which are separated by shutters facilitating ions of a user-selected, i.e., library-defined drift time to be introduced into the second drift tube whereas other ions of a different mobility are discarded as needed. The IMS and ITMS devices disclosed herein facilitate multiple opportunities to isolate ions of interest including ion separation and selection in the first drift tube, predetermined modification through fragmentation through a controllable electric field, and selected transmission into the second drift tube ultimately ending with specific identification of the ions. Regulation of the electric field strength and temperature analyte ions from one compound may dissociate and form dissociation products that can further be characterized, while ions from another compound may dissociate as well but form different products or may even not dissociate at all. As such, this dissociation information is important for providing another dimension of characterizing the mobility of ions by their stability and their dissociation products which provides additional confidence in the presence or absence of peaks that facilitates determining if an alarm could be generated or rejected. The results are more easily interpreted and provide more definitive information that can be used for the characterization of ions since only ions of a particular drift time are exposed to the high electric field and the associated fragmentation. Consequently substantially all dissociation products detected in the second drift tube originate from the ions selected from the first drift tube and subsequently fragmented. Moreover, the additional optional introduction of dopants facilitates further modification of the selected ions through chemical reactions with or without dissociation. As such, the systems described herein facilitate an additional level of selectivity that dramatically reduces the false alarm rate from that observed on traditional IMS and ITMS systems. Therefore, the portable mobility spectrometers described herein facilitate substance analysis with higher confidence while maintaining atmospheric pressure operation.

A technical effect of the systems and methods described herein includes at least one of: (a) substantially decreasing the frequency of false alarms in TOF-IMS and -ITMS detection systems; (b) facilitating ions of a user-selected, i.e., library-defined drift time to be introduced into a second drift tube where other ions of a different mobility are discarded as needed; (c) executing predetermined modification of selected ions through fragmentation with a controllable electric field; (d) regulating the electric field strength and temperature such that analyte ions from one compound dissociate and form dissociation products that can further be characterized while ions from other compounds either dissociate and form different products or not dissociate at all; (e) increasing dissociation information for further characterizing the mobility of ions by their stability and their dissociation products; (f) increasing confidence in the presence or absence of peaks that facilitates determining if an alarm could be generated or rejected; and (g) weakening ionic bonds through leveraging weakening of such bonds due to the electrostatic charge of the ion and increased thermal energy of the ion until ion fragmentation into the predetermined ion fragments is achieved, thereby further facilitating identifying chemical families primarily based on the way the analyte ions fragment.

Although specific features of various embodiments of the invention may be shown in some drawings and not in others, this is for convenience only. In accordance with the principles of the invention, any feature of a drawing may be referenced and/or claimed in combination with any feature of any other drawing.

Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the term processor and processing device.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. An apparatus for detecting constituents in a sample, said apparatus comprising:
a first drift tube defining a first drift region;
a second drift tube defining a second drift region;
a controllable electric field device coupled to said first drift tube and said second drift tube, said controllable electric field device at least partially defining a fragmentation region comprising a first wire grid, a second wire grid and a third wire grid spaced from each other along a longitudinal axis of the fragmentation region; and
a control system coupled to said controllable electric field device for controlling injection of a selected portion of ions of the sample into said second drift region, said control system further controlling injection of a selected portion of ions of the sample from said first drift region into said fragmentation region, and regulating said controllable electric field device to modify the selected portion of ions to generate predetermined ion fragments within said fragmentation region.

2. The apparatus of claim 1 wherein the first wire grid and the second wire grid are spaced from each other by a distance ranging from 10 μm to 2 mm.

3. The apparatus of claim 1 wherein the second wire grid and the third wire grid are spaced from each other by a distance ranging from 0.1 mm to 8 mm.

4. The apparatus of claim 1 further comprising a first ion shutter positioned between said first drift region and said fragmentation region, said first ion shutter being coupled with the control system.

5. The apparatus of claim 4 wherein said control system is configured to regulate the first ion shutter a first predetermined temporal period in order to control the injection of the selected portion of ions from the first drift region into the fragmentation region.

6. The apparatus of claim 1 further comprising an ion trap positioned between the fragmentation region and the second drift region, wherein the control system is further coupled to the ion trap and configured to regulate the ion trap for a second predetermined temporal period in order to inject a selected portion of the predetermined fragmented ions into the second drift region.

7. The apparatus of claim 1 further comprising: an ion detector positioned downstream of said second drift region; and a spectral analysis device coupled to said ion detector, said spectral analysis device configured to generate a detection spectrum representative of ions detected at said ion detector.

8. A mobility spectrometer for detecting constituents in a sample, wherein the mobility spectrometer comprises:
a first drift tube defining a first mobility stage;
a second drift tube defining a second mobility stage;
a controllable electric field device coupled to said first drift tube and said second drift tube, said controllable electric field device at least partially defining a fragmentation region comprising a first wire grid, a second wire grid and a third wire grid, wherein the first wire grid is situated upstream with respect to the second wire grid and the third wire grid within the fragmentation region, and the third wire grid is situated downstream with respect to the first wire grid and the second wire grid within the fragmentation region, and wherein the first wire grid and the third wire grid are separated by a distance ranging from 0.1 mm to 8 mm; and
a processor coupled to said first and second drift tubes and said controllable electric field, wherein the processor is configured to detect the sample as a sample of interest if:
the sample ionizes within the spectrometer forming a product ion distinctive of the sample of interest;
the product ion exhibits a first predefined drift time corresponding to the sample of interest in the first mobility stage;
the product ion fragments at a predefined electric field value within the fragmentation region; and
the product ion, or portions thereof, exhibit a second predefined drift time corresponding to the sample of interest in the second mobility stage.

9. The mobility spectrometer of claim 8 further comprising a first ionization source coupled with a first drift region for ionizing the sample to form sample ions, wherein the sample ions are injected into the first drift region; and a control system coupled to said controllable electric field device for controlling injection of a selected portion of the sample ions into a second drift region, said control system further controlling injection of a selected portion of the sample ions from said first drift region into said fragmentation region; and regulating said controllable electric field device to modify the selected portion of ions to generate predetermined ion fragments within said fragmentation region.

10. The mobility spectrometer of claim 9 further comprising:
an ion detector positioned downstream of said second drift region; and
a spectral analysis device coupled to said ion detector, said spectral analysis device configured to generate a detection spectrum representative of ions detected at said ion detector.

11. The mobility spectrometer of claim 10 wherein the processor is coupled with said spectral analysis device.

12. The mobility spectrometer of claim 8 wherein the first wire grid and the second wire grid are spaced from each other by a distance ranging from 10 μm to 2 mm.

13. The mobility spectrometer of claim 8 wherein the second wire grid and the third wire grid are spaced from each other by a distance ranging from 0.1 mm to 8 mm.

14. The mobility spectrometer of claim 9 further comprising a first ion shutter positioned between said first drift region and said fragmentation region wherein the first ion shutter is coupled with the control system.

15. The mobility spectrometer of claim 14 wherein said control system is configured to regulate the first ion shutter for a first predetermined temporal period and control the injection of the selected portion of ions from the first drift region into the fragmentation region.

16. The mobility spectrometer of claim 14 further comprising an ion trap positioned between said fragmentation region and said second drift region, wherein said control system is further coupled to said ion trap and configured to regulate the ion trap for a second predetermined temporal period in order to inject a selected portion of the predetermined fragmented ions into said second drift region.

17. A method of detecting a presence of a composition of matter in a sample, said method comprising:
channeling a sample gas into an ionization region;
generating a plurality of ions in the ionization region;
injecting at least a portion of the ions from the ionization region into a first drift region;
injecting a selected portion of ions from the first drift region into a fragmentation region, wherein the fragmentation region is defined by a first wire grid, a second wire grid and a third wire grid, wherein the first wire grid is situated upstream with respect to the second wire grid and the third wire grid within the fragmentation region, and the third wire grid is situated downstream with respect to the first wire grid and the second wire grid within the fragmentation region, and wherein the first wire grid and the third wire grid are separated by a distance ranging from 0.05 mm to 10 mm; and
detecting the sample as the composition of matter if and only if the sample ionizes within the spectrometer forming a product ion distinctive of the composition of matter, the product ion exhibits a first predefined drift time corresponding to the composition of matter in the first mobility stage, the product ion fragments at a predefined electric field value within the fragmentation region, and the product ion, or portions thereof, exhibit a second predefined drift time corresponding to the composition of matter in the second mobility stage.

18. The method of claim 17 further comprising maintaining a distance ranging from 10 μm to 2 mm between the first wire grid and the second wire grid.

19. The method of claim 17 further comprising maintaining a distance ranging from 0.05 mm to 10 mm between the second wire grid and the third wire grid.

20. The method of claim 17 wherein the ionization region is situated upstream with respect to the first drift region.

21. The method of claim 17 further comprising performing a controlled injection of a selected portion of the ions from said first drift region into the fragmentation region, regulating a controllable electric field device coupled with the fragmentation region to modify the selected portion of ions to generate predetermined ion fragments within the fragmentation region, and performing a controlled injection of a selected portion of the ion fragments into the second drift region.

22. The method of claim 21 further comprising regulating a first ion shutter for a first predetermined temporal period and controlling the injection of the selected portion of ions from said first drift region into said fragmentation region, wherein the first ion shutter is positioned between the first drift region and the fragmentation region.

23. The method of claim 21 further comprising regulating an ion trap for a second predetermined temporal period in order to inject a selected portion of the ion fragments into the second drift region, wherein the ion trap is positioned between the fragmentation region and the second drift region.
